(19) United States
(12) Patent Application Publication
(10) Pub. No.: US 2024/0023077 A1
(43) Pub. Date: Jan. 18, 2024

(54) SYSTEMS AND METHODS FOR SPECTRUM SHARING

(71) Applicant: Telefonaktiebolaget LM Ericsson (publ), Stockholm (SE)

(72) Inventors: Vijaya YAJNANARAYANA, BANGALORE (IN); Ajay KATTEPUR, BANGALORE (IN); Prayag Gowgi SOMANAHALLI KRISHNA MURTHY, MANDYA Karnataka (IN); Ramamurthy BADRINATH, KARNATAKA (IN)

(73) Assignee: Telefonaktiebolaget LM Ericsson (publ), Stockholm (SE)

(21) Appl. No.: 18/032,136

(22) PCT Filed: Oct. 16, 2020
(86) PCT No.: PCT/IB2020/059770

§ 371 Date: Apr. 14, 2023

(51) Int. Cl. H04W 72/0453; H04W 16/14; H04W 72/56

(52) U.S. Cl. CPC H04W 72/0453; H04W 16/14; H04W 72/56

(57) ABSTRACT

Methods (600) and systems (700) for selecting a frequency band for a device. In one aspect, the method comprises receiving (s602) from the device a request for a particular service type. The method further comprises determining (s604) a set of two or more frequency bands that are available for the device. Said set of two or more frequency bands comprises a first frequency band and a second frequency band. The method further comprises selecting (s606), based on the particular service type being requested and at least one of a knowledge base or a machine learning (ML) model, one of the frequency bands included in the set of two or more frequency bands.

### TECHNICAL FIELD

Disclosed are embodiments related to systems and methods for spectrum sharing.

### BACKGROUND

A radio frequency (RF) spectrum constitutes a portion of electromagnetic continuum and is usually subjected to regulated use. With the development of wireless communication technology, the spectrum resources (i.e., frequency bands) are becoming scarce. Dynamic spectrum sharing is a promising solution for this problem.

There are several factors one should take into account when choosing a frequency band for an application. The factors include the regulations that exists for the spectrum and the degree to which the frequency band is currently being utilized.

Current techniques utilize a spectral sensing approach to determine the degree to which a frequency band is currently being used. The spectral sensing helps in identifying the free area of the spectrum.

### SUMMARY

Certain challenges presently exist. For example, the basic spectrum sensing approach does not take into account relationships between application types, the types of interference that can be handled by applications, and Quality of Service (QoS) requirement and regulations.

Accordingly, this disclosure provides systems and method for selecting a frequency band for a device. In one embodiment the method includes receiving from the device a request for a particular service type. The method further includes determining a set of two or more frequency bands that are available for the device, said set of two or more frequency bands comprising a first frequency band and a second frequency band. The method further includes selecting, based on the particular service type being requested and at least one of a knowledge base or a machine learning (ML) model, one of the frequency bands included in the set of two or more frequency bands. Accordingly, some specific embodiments provide cognitive technology-based Artificial Intelligence (AI) solutions. The embodiments disclosed herein provide good spectral reuse and thereby improve spectrum utilization. Simple spectral sensing alone generally cannot make suitable choice for spectral sharing bands.

In some specific embodiments of this disclosure, there is provided a method to utilize cognitive core which identifies the complex relations between bands, applications, services, etc. in the form a knowledgebase. A cognitive core service may be offered to the ML agents which utilizes the proposed knowledge base and reasoning engine to aid the inference. The agents may further propose changes in modulation, coding or QoS requirements to applications.

In one aspect there is provided a method for selecting a frequency band for a device. The method comprises receiving from the device a request for a particular service type. The method further comprises determining a set of two or more frequency bands that are available for the device. Said set of two or more frequency bands comprises a first frequency band and a second frequency band. The method further comprises selecting, based on the particular service type being requested and at least one of a knowledge base or a machine learning (ML) model, one of the frequency bands included in the set of two or more frequency bands.

In another aspect there is provided a computer program comprising instructions which when executed by processing circuitry cause the processing circuitry to perform the method described above.

In another aspect there is provided a system for selecting a frequency band for a device. The system is configured to receive from the device a request for a particular service type. The system is further configured to determine a set of two or more frequency bands that are available for the device. Said set of two or more frequency bands comprising a first frequency band and a second frequency band. The system is further configured to select, based on the particular service type being requested and at least one of a knowledge base or a machine learning (ML) model, one of the frequency bands included in the set of two or more frequency bands.

In another aspect, there is provided an apparatus comprising a memory and processing circuitry coupled to the memory. The apparatus is configured to perform the method described above.

The embodiments of this disclosure provide at least the following advantages.
(1) Incorporating knowledge whether interferences applications (radar, AR/VR, video, IoT) can or cannot handle such that superior spectrum allocation is allowed (rather than merely looking at heat maps.)
(2) Rather than blindly allocating, making use of knowledge dependency graph from the cognitive core to reason about spectrum allocation/interference.
(3) Suggesting different types of encoding/modulation depending on application type, current congestion, possible quality of experience (QoE) requirements.
(4) Preventing future interference or deterioration in QoE by using a machine learning agent that continuously learns from spectrum allocation of primary/secondary applications.

### BRIEF DESCRIPTION OF THE DRAWINGS

The accompanying drawings, which are incorporated herein and form part of the specification, illustrate various embodiments.

FIG. 1 is a communication system according to some embodiments.

FIG. 2 is a method for selecting a frequency band for spectrum sharing according to some embodiments.

FIG. 3 is an example of a knowledge graph according to some embodiments.

FIG. 4 is an example of a knowledge graph according to some embodiments.

FIG. 5 is a method for selecting a frequency band for spectrum sharing according to some embodiments.

FIG. 6 shows a process according to an embodiment.

FIG. 7 shows an apparatus according to an embodiment.

### DETAILED DESCRIPTION

The usage of the RF spectrum depends on several practical concerns such as channel-bandwidth, antenna size, targeted coverage, etc. For example, if having a wide targeted radio coverage is critical or important for offering a particular service, then the frequency band in which the particular service operates needs to be in the lower range of the RF spectrum (i.e., the lower frequency band). On the other hand, for services which require large bandwidth but are used and/or provided by devices having small antennas, the higher range of the RF spectrum (i.e., the higher frequency band) is suitable.

Within the RF spectrum, the frequency range between 30 MHz and 6 GHz offers generally good propagation and achievable bandwidth that is adequate for most purposes. Therefore, it is desirable to share the usage of this frequency range.

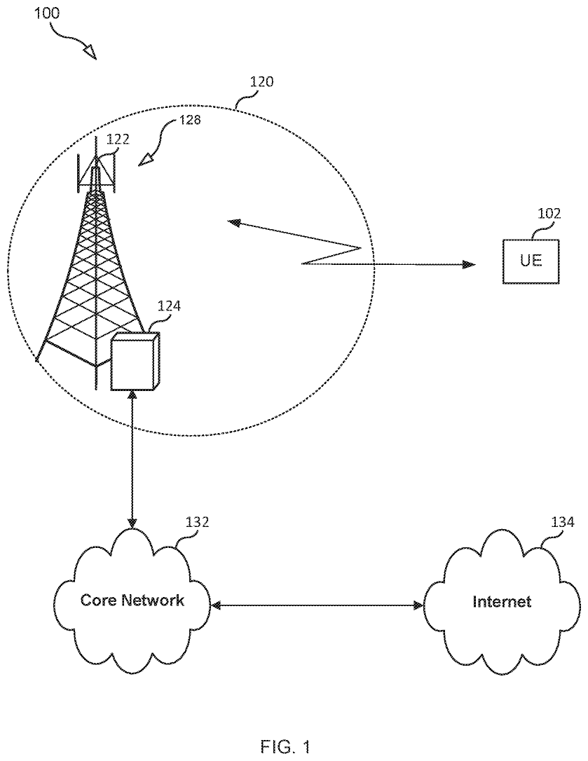

FIG. 1 shows a simplified view of an exemplary communication system 100 for sharing a frequency band. System 100 comprises user equipment(s) (UE) 102, a radio access network (RAN) 120, a core network 132, and internet 134.

UE 102 is any device capable of wirelessly transmitting and/or receiving data via RAN 120. For example, UE 102 may be an Internet of Thing (IoT) (e.g., a smart thermostat, a security camera), a television, a radar, and/or a mobile phone.

RAN 120 provides a connection between UE 102 and core network 132. As shown in FIG. 1, RAN 120 may comprise a base station 128 which includes an antenna 122 and a baseband unit 124. Base station 128 is connected to core network 132 via a backhaul (e.g., a fiber backhaul) and core network 132 is connected to a packet data network (PND) (e.g., the Internet) 134. Through RAN 120 and core network 132, UE 102 accesses PDN 134.

In order to access PDN 134 via RAN 120, UE 102 must use a certain frequency band of the RF spectrum to transmit/receive data to/from antenna 122. If any of the frequency bands that UE 102 is permitted to use (e.g., determined by a government body such as the Federal Communications Commission (FCC)) is available, UE 102 may just use the available frequency band(s). In some situations, however, all of the frequency band(s) that UE 102 is permitted to use are already used by other UEs. In such situations, it may be desirable for UE 102 to use a frequency band that is already used by another UE. In other words, there may be a situation where it is desirable for multiple UEs to share a frequency band.

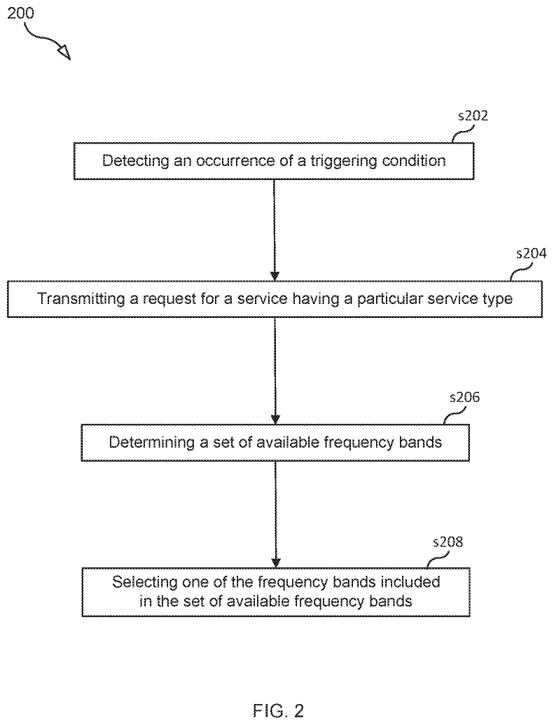

FIG. 2 shows a method 200 for selecting a frequency band that is to be shared by multiple UEs according to some embodiments. Method 200 may be performed by one or more components (e.g., base station 128) of communication system 100.

Method 200 may begin with step s202. In step s202, UE 102 detects an occurrence of a triggering condition. Examples of the triggering condition include powering up UE 102, restarting/initializing UE 102, launching an application (software) at UE 102, or receiving at UE 102 a command from the user of UE 102 (e.g., detecting the user's actuation of a button of the UE 102) or any other control entity (e.g., a server).

After detecting the occurrence of the triggering condition, in step s204, UE 102 transmits toward base station 128 a request for a service having a particular service type. For example, in case UE 102 is a security camera installed on a road, upon powering up the security camera, the security camera may transmit toward base station 128 a request for using the wireless network provided by base station 128 to transmit a video of security camera footage to a server. Here, the transmission of video of security camera footage via the wireless network corresponds to a service type. In some embodiments, a type of the device itself (which sent the request) may correspond to a service type (especially when the number of services a device can provide is few). For example, in case UE 102 is a smart thermostat, the services the smart thermostat can provide may be limited to providing temperature data to a remote user and receiving a temperature control command from the remote user. In such case, the type of device—“thermostat”—may directly correspond to the type of service—transmitting/receiving data.

After base station 128 receives the request, in step s206, an entity included in RAN 120 (e.g., base station 128 or any other component in RAN 120) identifies or determines a set of frequency bands that are available for UE 102. In some embodiments, the set of available frequency bands for UE 102 may be identified and/or determined using a (dynamic) spectrum sensing or a machine learning (ML) model. The spectrum sensing and/or the ML model may be used to identify an emission free region (i.e., a spectral hole in the spectral range of interest) in the RF spectrum to determine the set of available frequency bands for the requested service type.

In some embodiments, finding the emission free region using the spectrum sensing may be posed as a binary hypothesis problem of determining H₀ and H₁, where H₀ represents that a particular spectral region is free and H₁ represents that a particular spectral region is busy. More specifically, if H₀ is true, the spectral region is considered to be free. On the other hand, if H₁ is true, the spectral region is considered to be occupied.

$${H}_{0} : T = {\sum }_{n = 0}^{N - 1} w ( n ) \\ {H}_{1} : T = {\sum }_{n = 0}^{N - 1} s ( n ) + w ( n ) \qquad Equation ( 1 )$$

w(n) represents noise from a receiver. It may be modeled as independent and identically distributed (iid) Gaussian samples. s(n) is a sampled version of RF waveform that exists in the spectral region (frequency band) which is being tested for the occupancy. N is the number of samples used for hypothesis testing. T is the test-statistic obtained using the hypothesis testing strategy specified.

In some embodiments, the test-statistic T may be compared against a threshold value. In those embodiments, if T is less than the threshold value, the spectral region is determined to be free. Otherwise, the spectral region is determined to be occupied.

Referring back to FIG. 2, after determining the set of frequency bands that are available for UE 102, in step s208, the entity in RAN 102 may select, based on the requested service type, one of the frequency bands included in the set of available frequency bands.

In one embodiment, the entity in RAN 102 may select one of the frequency bands using a knowledge graph.

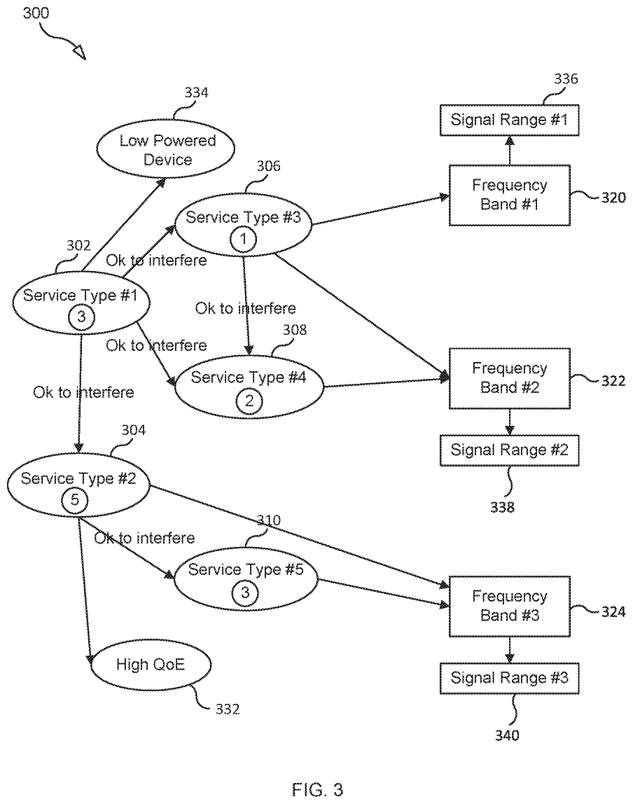

FIG. 3 shows an example of a simplified knowledge graph 300 according to some embodiments. The number and/or the structure of nodes 302-340 included in knowledge graph 300 are provided for illustration purpose only and do not limit the embodiments of this disclosure in any way.

Knowledge graph 300 comprises nodes 302-310 each corresponding to a particular service type (e.g., making a phone call, transmitting data, etc.). More specifically, nodes 302, 304, 306, 308, and 310 correspond to service types #1, #2, #3, #4, and #5, respectively. In some embodiments, as discussed above, a particular device type (e.g., an IoT, a mobile phone, a radar, a radio, a television, etc.) itself may identify a particular service type.

As shown in FIG. 3, each of service types #1-5 may be given a level of priority for using a frequency band. More specifically, in knowledge graph 300, service types #1, #2, #3, #4, and #5 are given priority levels of 3, 5, 1, 2, and 3, respectively. Thus, for example, service type #3 (corresponding to node 306) has a priority of using a certain frequency band over any other service types (corresponding to nodes 302, 304, 308, and 310). Even though, in FIG. 3, a positive integer is used to indicate a priority level associated with each of service types #1-5, any other format may be used to indicate the priority level.

Each of service types #1-5 may tolerate different levels and/or types of interference/noise composition in the operating spectral band. More specifically, as shown in FIG. 3, each of nodes 302-310 is connected to another node among nodes 302-310. The arrow between the two nodes may indicate whether the service type corresponding to one of the two nodes may interfere with the service type corresponding to another of the two nodes. For example, the arrow from node 302 to node 304 may indicate that service type #1 (corresponding to node 302) may interfere with service type #2 (corresponding to node 304). Similarly, the arrow from node 302 to node 306 may indicate that service type #1 may interfere with service type #3. On the other hand, absence of an arrow from node 302 to node 310 may indicate that service type #1 may not interfere with service type #5.

In one example, service type #1 corresponds to a radar-based applications and service type #5 corresponds to voice or video calling services. Since some radars like pulsed radars have very large peak to average performance, these applications create large short-term interference. Because voice or video calling services cannot cope with these short-term noise interference, service type #1 (the radar-based applications) may not interfere with service type #5 (voice or video calling services).

One or more of nodes 302-310 may also be connected to node 332 or 334. Each of node 332 and 334 indicates a characteristic of the service identified by the node connected to node 332 or 334. For example, in FIG. 3, node 306 corresponding to service type #3 is connected to node 332 corresponding to high quality of experience (QoE). This connection means that the service type #3 requires high QoE. Similarly, that node 308 (corresponding to service type #4) is connected to node 334 (corresponding to low powered device) indicates that service type #4 is provided by a low powered device.

Knowledge graph 300 also includes nodes 320-324 each corresponding to a certain frequency band. More specifically, nodes 320, 322, and 324 correspond to frequency bands #1 (e.g., the frequency band between 30 kHz and 300 kHz), #2 (e.g., the frequency band between 3 MHz and 30 MHz), and #3 (e.g., the frequency band between 3 GHz and 30 GHz), respectively.

In some embodiments, each of frequency bands #1, #2, and #3 may correspond to a respective class among a plurality of classes. For example, frequency band #1 may correspond to a primary class (allocation) while frequency band #2 may correspond to a secondary class (allocation). The services which use the frequency band of the primary class (allocation) may afford incumbent service protection against interference from the services which use the frequency band of the secondary class (allocation). In addition to the primary class and the secondary class, the plurality of classes may also include a class which offers no protection against noise and interference.

As shown in FIG. 3, each of nodes 320-324 is connected to at least one of nodes 302-310. The arrow between the two nodes may indicate whether the frequency band to which one of nodes 320-324 corresponds is available for the service type to which one of nodes 302-310 corresponds. For example, the arrow between node 306 and node 322 may indicate that the frequency band #2 (corresponding to node 322) is available for service type #3 (corresponding to node 306). Even though it is not shown in FIG. 3, all of frequency bands #1, #2, and #3 are available for service type #1 (corresponding to node 302).

In some embodiments, nodes 320-324 are also connected to nodes 336-340. Each of nodes 336-340 may indicate the range of signal transmission and/or reception (“signal range”) allowed by a certain frequency band. For example, the connection between node 320 and node 336 may indicate that frequency band #1 (corresponding to node 320) permits the signal range #1 (corresponding to node 336).

In some embodiments, knowledge graph 300 can be queried with implicit knowledge inferenced using ML models, and the structure of knowledge graph 300 may involve with improved inferencing and/or allocation actions.

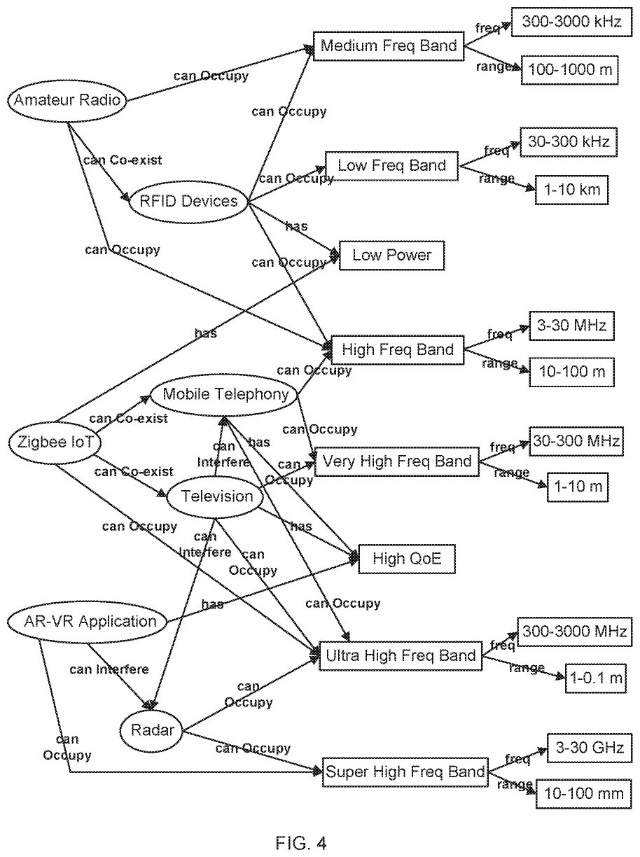

FIG. 4 shows an example of a high level knowledge graph 400 according to some embodiments. The number and/or the structure of nodes included in knowledge graph 400 are provided for illustration purpose only and do not limit the embodiments of this disclosure in any way.

Like knowledge graph 300, knowledge graph 400 represents various services (applications), their operational frequency bands, and constraints on operations. These constraints may be due to operations (interference or noise) or regulations.

The following exemplary inferences may be made regarding knowledge graph 400.
(1) ZigBee IoT is a low powered device and operates at the ultra high frequency (UHF) Band (300-3000 MHz). If the IoT is treated as a secondary user, it may coexist with television or mobile telephony applications with minimal interference.
(2) Operating in the same UHF band, both television and mobile telephony have requirements of high QoE, and thus spectrum holes that are nearby the UHF band should not be allowed for both applications as the possibility of interference is high.
(3) Radar and augmented reality (AR)/virtual reality (VR) applications occupy super high frequencies and have high QoE requirements. Thus, secondary users should be notified of these occupation and must not generate interference.

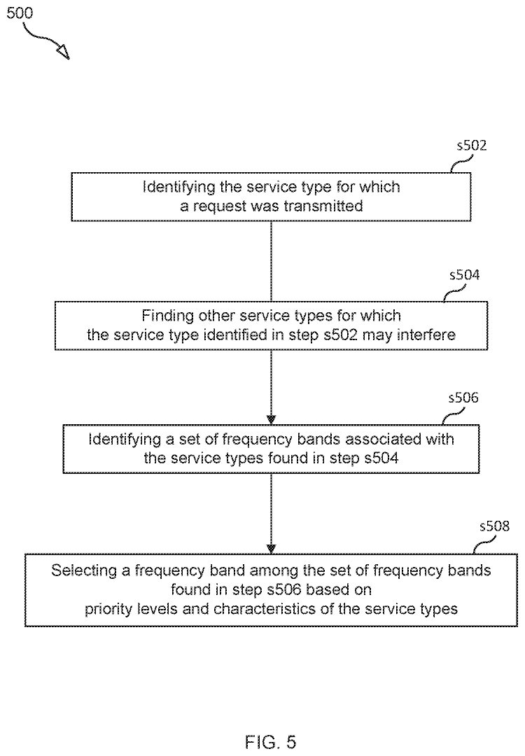

Referring back to FIG. 2, as discussed with respect to step s208, knowledge graph 300 may be used to find a frequency band for spectrum sharing. FIG. 5 shows a method 500 for finding the frequency band using knowledge graph 300 according to some embodiments. Method 500 may begin with step s502.

Step s502 comprises identifying the service type for which the request was transmitted in step s204.

Step s504 comprises finding other service types with which service type #1 may interfere. In knowledge graph 300, service type #1 may interfere with service types #2, #3, and #4.

Step s506 comprises identifying a set of frequency bands associated with the service types identified in step s504. In knowledge graph 300, as discussed above, service types #2, #3, and #4 are identified in step s504. Since service types #2, #3, and #4 are associated with frequency bands #1 and #2, frequency bands #1 and #2 are identified in step s506.

Step s508 comprises selecting a frequency band among the set of frequency bands found in step s506 based on priority levels and characteristics of the service types. For example, in knowledge graph 300, among service types #2, #3, and #4 identified in step s504, the priority level of service type #2 (e.g., 5) is higher than the priority level of service type #1 (e.g., 3). Also as shown by node 332, device type #2 requires high QoE. Due to the higher priority level and the requirement of high QoE of service type #2, it may be determined that service types #1 and #2 may not share a frequency band. Thus, in step s508, frequency band #3 that is associated with service type #2 is not selected.

Furthermore, as indicated by node 334, service type #1 is operated by a low powered device which has a relatively low transmission power. As a result, signal transmission range for service type #1 may be relatively low. In such case, among the frequency bands #1 and #2 associated with the remaining service types #3 and #4, it may be desirable to select a low frequency band which allows greater signal transmission range. Thus, in case frequency band #1 is a low frequency band, in step s508, frequency band #1 is selected.

As mentioned above, in step s208, a frequency band for spectrum sharing may be selected using a machine learning (ML) model instead of a knowledge graph.

The ML model may be configured to output a frequency band to be used for spectrum sharing based on ML inputs. The ML inputs may include a particular service type for which the request was made in step s204 in FIG. 2 and a set of two or more frequency bands that are available for the particular service type.

The ML model may be trained using supervised learning. For example, a frequency band that was found to be ideal for spectrum sharing for a particular service type (based on evaluating actual quality of the service having the service type when the frequency band is used for spectrum sharing for the service type) may be provided to the ML model as ML output, and (i) the particular service type and (ii) a set of frequency bands available for the particular service type may be provided to the ML model as the ML inputs. The ML model may be trained (e.g., change its weights) such that it becomes to be configured to output as its output the frequency band that was found to be ideal using the aforementioned ML inputs.

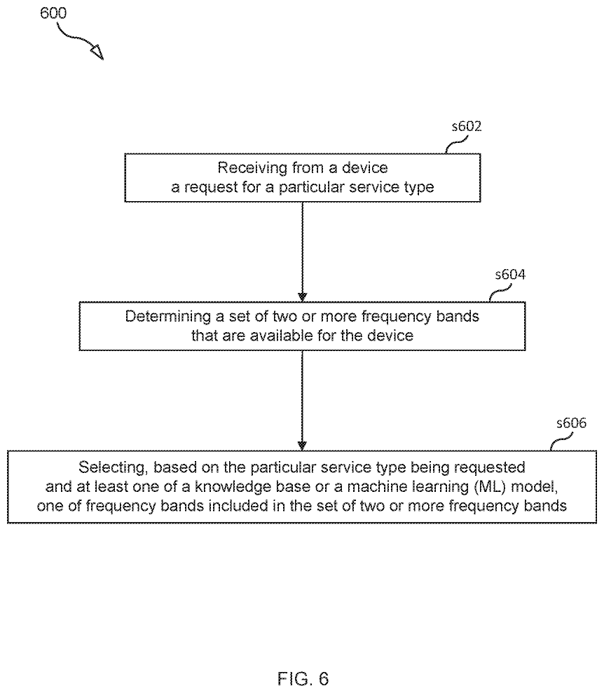

FIG. 6 shows a process 600 for selecting a frequency band for a device. Process 600 may begin with step s602.

Step s602 comprises receiving from the device a request for a particular service type.

Step s604 comprises determining a set of two or more frequency bands that are available for the device. Said set of two or more frequency bands comprises a first frequency band and a second frequency band.

Step s606 comprises selecting, based on the particular service type being requested and at least one of a knowledge base or a machine learning (ML) model, one of the frequency bands included in the set of two or more frequency bands.

In some embodiments, said one of the frequency bands is selected based on at least one of the followings: a priority level of the service type, a degree of interference that the service type can handle, a Quality of Service (QoS) requirement for the service type, a transmit power required for the service type, and/or a location of the device.

In some embodiments, the selecting is further based on information associated with the device.

In some embodiments, the information associated with the device comprises subscription information identifying a type of subscription plan the device is registered on.

In some embodiments, the method further comprises, prior to the selecting step (c): identifying a primary service associated with said first frequency band; and obtaining interference information indicating a degree of interference that said primary service can tolerate.

In some embodiments, the method further comprises identifying a primary service associated with said first frequency band; and obtaining frequency information indicating how often a device utilizing the primary service needs to communicate with a network node.

In some embodiments, the method further comprises identifying a primary service associated with said first frequency band, wherein the primary service is of a first service type; and obtaining priority information indicating a priority level of the first service type.

In some embodiments, the steps (b) and (c) are performed periodically.

In some embodiments, the method is performed by a radio access network (RAN).

In some embodiments, the step (c) is performed by a machine learning (ML) agent implemented in the RAN.

In some embodiments, the knowledge base is in the form of a directed-graph or a database.

In some embodiments, the directed-graph or the database relates the service type with a subset of one or more frequency bands, and said subset of one or more frequency bands is a subset of said set of two or more frequency bands.

In some embodiments, the selecting of said one of the frequency bands is performed based on the knowledge base and the knowledge base is a knowledge graph. The knowledge graph may comprise a first group of nodes each of which identifies a device type and/or a service type, a second group of nodes each of which identifies a device type and/or a service type, wherein the second group of nodes is connected to the first group of nodes via a first group of links and further wherein each of the first group of links indicates a relationship between one of the first group of nodes and one of the second group of nodes, and a third group of nodes each of which identifies a categorized frequency band, wherein the third group of nodes is connected to the first and/or second group of nodes via a second group of links and further wherein each of the second group of links indicates whether a device type and/or a service type identified by one of the first or second group of nodes can occupy the categorized frequency band of one of the third group of nodes.

In some embodiments, the selecting of said one of the frequency bands is performed using the ML model. The method further comprises, prior to performing the step (a): providing to the ML model ML input data and ML desired output data; and training the ML model using the ML input data and the ML desired output data. The ML input data comprises any one or a combination of the followings: a priority level of a service type, a degree of interference that a service type can handle, a Quality of Service (QoS) requirement for a service type, a transmit power required for a service type, and/or a location of the device.

In some embodiments, the selecting step (c) further comprises: identifying, among a first group of nodes included in a knowledge graph, a node which identifies the particular service type; based on the determined set of two or more frequency bands, identifying, among a second group of nodes included in the knowledge graph, one or more nodes each of which identifies a service type, wherein the second group of nodes is connected to the first group of nodes via a group of links each of which indicates a relationship between one of the first group of nodes and one of the second group of nodes; and based on the relationship indicated by at least one of the links, selecting one of the frequency bands included in the set of two or more frequency bands.

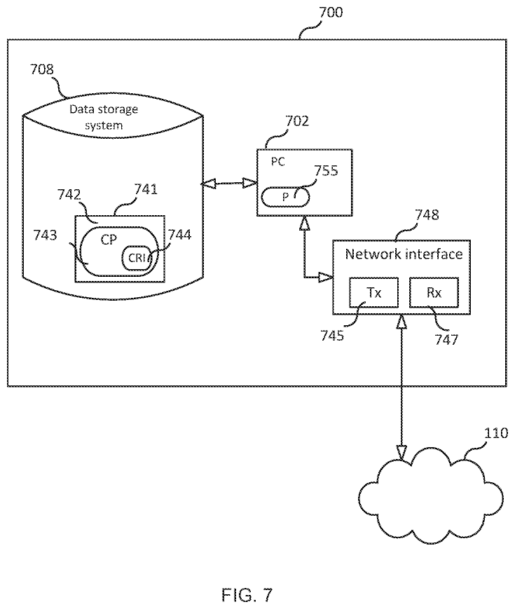

FIG. 7 is a block diagram of an apparatus 700, according to some embodiments, for implementing the entity included in RAN 120, which is configured to select one of the frequency bands in step s208. As shown in FIG. 7, apparatus 700 may comprise: processing circuitry (PC) 702, which may include one or more processors (P) 755 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 700 may be a distributed computing apparatus); a network interface 748 comprising a transmitter (Tx) 745 and a receiver (Rx) 747 for enabling apparatus 700 to transmit data to and receive data from other nodes connected to a network 110 (e.g., an Internet Protocol (IP) network) to which network interface 748 is connected (directly or indirectly) (e.g., network interface 748 may be wirelessly connected to the network 110, in which case network interface 748 is connected to an antenna arrangement); and a local storage unit (a.k.a., “data storage system”) 708, which may include one or more non-volatile storage devices and/or one or more volatile storage devices. In embodiments where PC 702 includes a programmable processor, a computer program product (CPP) 741 may be provided. CPP 741 includes a computer readable medium (CRM) 742 storing a computer program (CP) 743 comprising computer readable instructions (CRI) 744. CRM 742 may be a non-transitory computer readable medium, such as, magnetic media (e.g., a hard disk), optical media, memory devices (e.g., random access memory, flash memory), and the like. In some embodiments, the CRI 744 of computer program 743 is configured such that when executed by PC 702, the CRI causes apparatus 700 to perform steps described herein (e.g., steps described herein with reference to the flow charts). In other embodiments, apparatus 700 may be configured to perform steps described herein without the need for code. That is, for example, PC 702 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes and message flows described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for selecting a frequency band for a device, the method comprising:
(a) receiving from the device a request for a particular service type;
(b) determining a set of two or more frequency bands that are available for the device, said set of two or more frequency bands comprising a first frequency band and a second frequency band; and
(c) selecting, based on the particular service type being requested and at least one of a knowledge base or a machine learning (ML) model, one of the frequency bands included in the set of two or more frequency bands.

2. The method of claim 1, wherein said one of the frequency bands is selected based on at least one of the followings:
a priority level of the service type,
a degree of interference that the service type can handle,
a Quality of Service (QoS) requirement for the service type,
a transmit power required for the service type, and/or
a location of the device.

3. The method of claim 1, wherein the selecting is further based on information associated with the device.

4. The method of claim 3, wherein the information associated with the device comprises subscription information identifying a type of subscription plan the device is registered on.

5. The method of claim 1, the method further comprising, prior to the selecting step (c):
identifying a primary service associated with said first frequency band; and
obtaining interference information indicating a degree of interference that said primary service can tolerate.

6. The method of claim 1, further comprising:
identifying a primary service associated with said first frequency band; and
obtaining frequency information indicating how often a device utilizing the primary service needs to communicate with a network node.

7. The method of claim 1, further comprising:
identifying a primary service associated with said first frequency band, wherein the primary service is of a first service type; and
obtaining priority information indicating a priority level of the first service type.

8. The method of claim 1, wherein the steps (b) and (c) are performed periodically.

9. The method of claim 1, wherein the method is performed by a radio access network (RAN).

10. The method of claim 9, wherein the step (c) is performed by a machine learning (ML) agent implemented in the RAN.

11. The method of claim 1, wherein the knowledge base is in the form of a directed-graph or a database.

12. The method of claim 11, wherein
the directed-graph or the database relates the service type with a subset of one or more frequency bands, and
said subset of one or more frequency bands is a subset of said set of two or more frequency bands.

13. The method of claim 1, wherein
the selecting of said one of the frequency bands is performed based on the knowledge base,
the knowledge base is a knowledge graph,
the knowledge graph comprises:
a first group of nodes each of which identifies a device type and/or a service type,
a second group of nodes each of which identifies a device type and/or a service type, wherein the second group of nodes is connected to the first group of nodes via a first group of links and further wherein each of the first group of links indicates a relationship between one of the first group of nodes and one of the second group of nodes, and
a third group of nodes each of which identifies a categorized frequency band, wherein the third group of nodes is connected to the first and/or second group of nodes via a second group of links and further wherein each of the second group of links indicates whether a device type and/or a service type identified by one of the first or second group of nodes can occupy the categorized frequency band of one of the third group of nodes.

14. The method of claim 1, wherein
the selecting of said one of the frequency bands is performed using the ML model,
the method further comprises, prior to performing the step (a):
providing to the ML model ML input data and ML desired output data; and
training the ML model using the ML input data and the ML desired output data, and the ML input data comprises any one or a combination of the followings:
a priority level of a service type,
a degree of interference that a service type can handle,
a Quality of Service (QoS) requirement for a service type,
a transmit power required for a service type, and/or
a location of the device.

15. The method of claim 1, wherein the selecting step (c) further comprises:
identifying, among a first group of nodes included in a knowledge graph, a node which identifies the particular service type;
based on the determined set of two or more frequency bands, identifying, among a second group of nodes included in the knowledge graph, one or more nodes each of which identifies a service type, wherein the second group of nodes is connected to the first group of nodes via a group of links each of which indicates a relationship between one of the first group of nodes and one of the second group of nodes; and
based on the relationship indicated by at least one of the links, selecting one of the frequency bands included in the set of two or more frequency bands.

16-20. (canceled)

21. An apparatus for selecting a frequency band for a device, the apparatus comprising a memory and processing circuitry coupled to the memory, the apparatus being configured to:
(a) receive from the device a request for a particular service type;
(b) determine a set of two or more frequency bands that are available for the device, said set of two or more frequency bands comprising a first frequency band and a second frequency band; and
(c) select, based on the particular service type being requested and at least one of a knowledge base or a machine learning (ML) model, one of the frequency bands included in the set of two or more frequency bands.

22. The apparatus of claim 21, wherein prior to the selecting step (c), the apparatus is configured to:
(i) identify a primary service associated with said first frequency band, and obtain interference information indicating a degree of interference that said primary service can tolerate,
(ii) identify a primary service associated with said first frequency band, and obtain frequency information indicating how often a device utilizing the primary service needs to communicate with a network node, and or
(iii) identify a primary service associated with said first frequency band, wherein the primary service is of a first service type, and obtain priority information indicating a priority level of the first service type.

23. The apparatus of claim 21, wherein
the selecting of said one of the frequency bands is performed based on the knowledge base,
the knowledge base is a knowledge graph,
the knowledge graph comprises:
a first group of nodes each of which identifies a device type and/or a service type,
a second group of nodes each of which identifies a device type and/or a service type, wherein the second group of nodes is connected to the first group of nodes via a first group of links and further wherein each of the first group of links indicates a relationship between one of the first group of nodes and one of the second group of nodes, and
a third group of nodes each of which identifies a categorized frequency band, wherein the third group of nodes is connected to the first and/or second group of nodes via a second group of links and further wherein each of the second group of links indicates whether a device type and/or a service type identified by one of the first or second group of nodes can occupy the categorized frequency band of one of the third group of nodes.

24. The apparatus of claim 21, wherein
the selecting of said one of the frequency bands is performed using the ML model,
the method further comprises, prior to performing the step (a):
providing to the ML model ML input data and ML desired output data; and
training the ML model using the ML input data and the ML desired output data, and the ML input data comprises any one or a combination of the followings:
a priority level of a service type,
a degree of interference that a service type can handle,
a Quality of Service (QoS) requirement for a service type,
a transmit power required for a service type, and/or
a location of the device.

25. The apparatus of claim 21, wherein the selecting step (c) further comprises:
identifying, among a first group of nodes included in a knowledge graph, a node which identifies the particular service type;
based on the determined set of two or more frequency bands, identifying, among a second group of nodes included in the knowledge graph, one or more nodes each of which identifies a service type, wherein the second group of nodes is connected to the first group of nodes via a group of links each of which indicates a relationship between one of the first group of nodes and one of the second group of nodes; and
based on the relationship indicated by at least one of the links, selecting one of the frequency bands included in the set of two or more frequency bands.
